(19) United States
(12) Patent Application Publication
(10) Pub. No.: US 2020/0302591 A1
(43) Pub. Date: Sep. 24, 2020

(54) EQUIPMENT MONITORING SYSTEM

(71) Applicant: Eaton Intelligent Power Limited, Dublin (IE)

(72) Inventors: Stewart Parfitt, Hertfordshire (GB); James Cooke, Pwllheli (GB); Joseph Michael Manahan, Manlius, NY (US)

(73) Assignee: Eaton Intelligent Power Limited, Dublin (IE)

(21) Appl. No.: 16/814,590

(22) Filed: Mar. 10, 2020

Related U.S. Application Data
(60) Provisional application No. 62/822,428, filed on Mar. 22, 2019.

(51) Int. Cl. G06T 7/00; G05B 19/042; H04N 7/18; G06T 11/00; G01M 99/00

(52) U.S. Cl. CPC G06T 7/0004; G05B 19/0428; H04N 7/185; G06T 2207/30164; G01M 99/005; G05B 2219/24024; G06T 2207/10016; G06T 11/00

(57) ABSTRACT

A equipment monitoring device configured to be worn by a user comprises an input interface module and an output interface module. The input interface module comprises an input sensor and is to receive operational data from at least one of a piece of equipment and a sensor, analyze the received data, and transmit analyzed data information. The output interface module is in communication with the input interface module and comprises a display. The output interface module is configured to receive the transmitted analyzed data information from the input interface module, and output the analyzed data information to the display. The analyzed data information is responsive to the received data and an input interface sensor is configured to automatically capture visual images of the piece of equipment in a line of sight of the user.

### CROSS-REFERENCE TO RELATED APPLICATIONS

This application claims the benefit of and priority to U.S. Provisional Patent Application Ser. No. 62/822,428, filed Mar. 22, 2019 and entitled “EQUIPMENT MONITORING”, the entirety of which is incorporated herein by reference.

### TECHNICAL FIELD

This disclosure generally relates to the monitoring of operational equipment and more specifically to a system including a mobile monitoring device configured to be carrier or worn by a use and that is configured to send, receive, store, and/or analyze and display information related to the operational equipment and/or the environment in which the operational equipment is located.

### BACKGROUND

Interaction with operational/processing equipment, sometimes in hazardous or remote environments, is often required for an operator to perform inspection, maintenance, start-up or shutdown of said equipment. However the efficiency and/or safety with which an operative can interact with the equipment is an important consideration and can affect the impact of equipment shutdown, operational interruption, and the safety and well-being operatives when interacting with the equipment.

Current procedures and best practices for working on and otherwise interacting with such equipment necessarily are focused on safety awareness, however it is up to the user to memorize such practices/procedures for all equipment and/or environments that the user may come into contact with, or manually look-up such practices/procedures while simultaneously performing the task required on the equipment. Moreover, the current procedures and best practices cannot account for or recognize unexpected operational characteristics so that efficient and safe interaction with the equipment cannot be achieved at all times.

These are just some of the shortcomings of equipment monitoring systems and associated methods currently in use.

### SUMMARY

The present disclosure is directed to an equipment monitoring system comprising a mobile electronic interface device and a related method of use. The equipment monitoring system and method of use is configured to allow for the identification and user-friendly display, indication, and/or notification of operational and environmental conditions associated with the equipment that could impact the efficiency and/or the safety of a user's interaction with the equipment.

In an embodiment, a mobile equipment monitoring device comprises a housing, an input interface module at least partially positioned within the housing, and an output interface module in communication with the input interface module and at least partially positioned within the housing. The input interface module comprises an input sensor. The input interface module is configured to receive operational data from the equipment and/or the sensor. The sensor is configured to sense and transmit data to the input interface module pertaining to an environmental parameter proximate a piece of equipment. The input interface module is further configured to analyze the received data and transmit analyzed data. The output interface module comprises a display and is configured to receive the transmitted analyzed data from the input interface module and output the analyzed data to the display, wherein the analyzed data is responsive to the received data. The housing is configured to be worn by the user and the input interface sensor is configured to automatically capture visual images of the piece of equipment in the user's line of sight.

In an embodiment, a method of equipment monitoring comprises receiving operational data pertaining to a piece of equipment being engaged by user and receiving environmental data regarding one or more environmental parameters proximate the piece of equipment. The received data is analyzed using one or more processors to determine operating status information of the equipment based on the operating data and to determine safety information based on the operating status and the environmental data. The operating status and safety information is then output to the user.

According to an embodiment, a mobile electronic interface device is configured for wireless communication with equipment requiring interaction with the user, such as for inspection or maintenance. The mobile electronic interface device may comprise an input interface module configured to receive operational data from the equipment and/or detect environmental data from the environment within which the equipment is located. The data is analyzed and transmitted to an output interface module that is in electronic communication with the input interface module. The output interface module is configured to receive information from the input interface module and output the information to the user in the form of a visual display, audio signal, haptic signal, or combinations thereof. In an embodiment, the mobile electronic interface device is configured to be worn by a user and includes the input and output interface modules. Accordingly, the mobile electronic interface device may enable the user to receive data concerning the equipment and/or the environment within which the equipment is located as soon as the user is in the vicinity of the equipment. As a result, the user may therefore be automatically apprised of characteristics or conditions of the equipment/environment and the user's subsequent actions may be performed in a manner readily responsive to such conditions. This is particularly important in situations where the conditions may affect the safety of the user during interaction with the equipment and/or the completion of the activity on the equipment by the user.

In an embodiment, the user may utilize the mobile electronic interface device to directly or indirectly interact with the equipment in a ‘hands free’ manner, thereby leaving the user's hands available for other tasks such as those requiring specific tools and/or manipulation. In an embodiment, the mobile electronic interface device is wearable and configured to be head-mounted or otherwise configured to be worn on the user's head. In this embodiment, the electronic interface device includes at least one outwardly facing aperture or sensor that is configured to face along the user's line of sight and detect/sense conditions of the environment and/or equipment (or part of the equipment) along the sight line. In this manner, the user receives information regarding the current environment the user is in and/or the specific piece of equipment (or part of the piece of equipment) the user is currently looking at and presumably engaging. Therefore, the user is not required to sift through information pertaining to environmental conditions and/or equipment that is not the focus of the user's current task.

In another embodiment, the output interface module of the head-mounted mobile electronic interface device further comprises a visual display means such as a liquid crystal display (LCD), light-emitting diode (LED) or organic LED display, or other suitable types of display. In another embodiment, the head-mounted mobile electronic interface device may be used in conjunction with an eyewear device such as, but not limited to, for example glasses, goggles, or a visor. The visual display may include augmented reality functionality, or virtual reality functionality. The eyewear device, in an embodiment, may comprise an integrated visual display is configured to display information for the user that is obtained by the input interface module. The integrated visual display may be configured as an augmented reality display or virtual reality display.

The output interface module may be further configured to output an audio signal, a tactile or a haptic/tactile signal, or any additional sensory output signal as may be required. In particular, the mobile electronic interface device may include an output interface module offering a plurality of different output formats which can be employed individually, or in one or more different combinations, depending on the nature of the equipment, the environment and/or the nature of the data/information to be output by the device. The output format may be selected through preference settings on the mobile electronic interface device. Alternatively, or in addition, the output format may be determined in a manner automatically responsive to characteristics of the equipment/environment.

In an embodiment, the input interface module is configured to receive output signals from the equipment to be inspected and/or characteristics of the environment in any appropriate format. The format could comprise, but is not limited to, a form of radiation such as infrared radiation (IR), audio and/or visual formats. The mobile electronic interface device may be further configured to accept and process data arising from an operational characteristic of the equipment and/or environment including, but not limited to, noise level, vibration level, temperature and gas concentration. Visual information may be in the form of any visual signaling and may comprise an image of the equipment including visual icons illustrating operational characteristics or conditions of the equipment. In an embodiment, the input interface module may comprise object recognition or image recognition software so as to allow for recognition of the equipment under inspection, or recognition of certain characteristics of the equipment under inspection.

In an embodiment, the input interface module and the output interface module may include at least partially shared functionality. For example, both the input interface module and output interface module may be configured to receive and capture at least one visual image of the equipment and visually display data relating to the equipment. In an embodiment, the display of visual data relating to the equipment may comprise a representation of at least part of the equipment. The display functionality of the mobile electronic interface device may be configured to provide an augmented reality representation. The augmented reality feature is configured to highlight or identify particular characteristics or component parts/sections of the equipment relevant to the user for inspection purposes and/or for user interaction purposes from an operational and/or safety standpoint.

Image capture functionality incorporated into the wearable electronic interface device may include a directional image capture element where the direction is selectable by the user. In particular for a head-mounted device, the orientation of the image capture element remains continually aligned with the user's line-of-sight. Accordingly, the mobile electronic interface module can automatically highlight or otherwise select and provide the operational characteristics/safety data/etc. of the particular equipment, or part of the equipment, being seen or otherwise worked on by the user (i.e, in the user's line-of-sight). In other words, although a variety of operational issues might be present in the equipment, only those issues relevant to the particular nature of inspection being undertaken by the user is output at the output interface module so that the user can concentrate on such information without distraction from data relating to other characteristics of the equipment that are not under current inspection.

In one embodiment of the invention, the mobile electronic interface device includes communication functionality configured to supply accepted operational data to a remote processing location and/or the received data from a remote processing location for subsequent output by the output interface module. The communication functionality may enable interaction with sensors positioned within the environment using a communications protocol such as Bluetooth connectivity in order to increase the monitoring capabilities of environmental features/characteristics by the system. The mobile electronic interface device itself may also include one or more sensors configured to sense one or more environmental parameters and/or deliver data pertaining to the sensed parameter to a remote device/location, and/or a further mobile electronic interface device present in the vicinity of the equipment of interest. In an embodiment, the majority, if not all, of the processing of the received operational data and/or sensor data in order to provide the data output required by a user may be conducted by way of such remote processing functionality. Accordingly, the data processing function is not limited to the capabilities of the mobile electronic interface device and, further, can be accomplished at a location remote from the equipment and/or the environment within which the equipment is operating.

In an embodiment, the mobile electronic interface device and/or the remote processing function associated therewith includes memory and processing means for the indexed storage of data relating to the operational and/or environmental characteristics identified, the manner of their identification, and the relationship between the characteristics and the manner of identification. The memory and processing means may comprise any known means. Subsequent functionality of the mobile electronic interface device may then be controlled with regard to previous equipment/environmental inspection as part of an adaptive process which can rely on known features of Artificial Intelligence.

In an embodiment, the data presented to a user may be presented in any appropriate format including any form of audio and/or visual and/or haptic format. The parameters and characteristics of these formats are also configured to be customized by the user. Examples of such customizable features include, but are not limited to, the speed and/or magnitude of any tactile/haptic feedback, the volume and/or frequency of any audio feedback and the brightness, color, movement of any visual feedback. For example, the format of visual display can be changed in order to emphasize the information to be imparted to the user. The use of augmented reality functionality can prove particularly advantageous in its overlay of data. In an example, the data overlay may comprise a representation of the equipment and the parts/sections thereof in a manner conveying a warning to the user.

In an embodiment, the mobile electronic interface is configured to receive and store, whether by way of a download procedure or otherwise, location and/or equipment specific data, through location determination means, such as geolocation or global positioning, as the user moves around the environment in which the equipment is located. This function is configured to occur automatically in response to the determination of the location of the device and/or once the user starts to interact with the equipment as determined by image recognition at input interface module. In a further embodiment, the mobile electronic interface device may comprise lockout/tag out functionality that controls user access to the equipment in a manner responsive to a third party lockout device. Such lockout/tag out functionality may be employed directly in relation to the mobile electronic interface device to prevent ‘unapproved’ access to the equipment whether due to current third-party access or otherwise. For example, a user may receive a warning if in close proximity to energized equipment which has not been locked out (hence safe to work on). Therefore maintenance schedules may be downloaded or integrated into the system using work-scheduling applications and lock out/tag out status of equipment to indicate readiness for maintenance work to commence.

In an embodiment, the output capabilities of the electronic interface device may comprise visual and/or audible alarms when the user moves into close proximity to equipment which is still energized (i.e. not locked out/tagged out). Accordingly, the equipment monitoring system may be configured to integrate work scheduling software such as lock out/tag out protocols and requiring completion before the job can be logged as started. In an embodiment, the mobile electronic interface device may use visual recognition to identify whether the lockout device is present or, the lockout device may be provided with communication capability for bidirectional communication with the electronic interface device. In either situation, the lockout device may also be assigned to the user of the mobile electronic interface device in order for that user to perform the require interaction with the equipment, for example for maintenance. Therefore, the equipment monitoring system may be used with multiple users, for example maintenance operatives, each of whom are required to perform maintenance on equipment, whether simultaneously or over multiple shifts while the equipment is down. Each operative or user may install their lockout device, which is facilitated through control at each respective electronic interface device. The electronic interface device may then be used to identify which operative is authorized to perform a particular task and which may have removed their lock because they have completed their task. The electronic interface device of the equipment monitoring system allows for an intuitive “check in” on other users that are working on the same equipment. When locks are assigned to individuals they typically include some kind of unique identification on them to associate them with the user. This could be the user's name, or bar code, etc . . . , but all of which the mobile electronic interface device and its input interface module can readily visually interpret.

In an embodiment, the electronic interface device is configured to be used within a hazardous environment and may further comprise Intrinsic Safety functionality configured to keep the available electrical circuit, under normal or abnormal conditions, so low that an ignition cannot occur. It will of course also be appreciated that the electronic interface device described may be part of an equipment monitoring system.

According to another embodiment, a method of equipment monitoring is provided and comprises receiving through an input interface module operational data from the equipment and/or environmental data from one or more sensors positioned the environment within which the equipment is located. The received data analyzed and transmitted as information to an output interface module and output to the user. The output information is responsive to the data received by the input interface module and providing the user with information on the equipment and/or the environment, and including the inspection of the equipment and/or environment. This aspect of the present invention can prove particularly advantageous insofar as a user wearing the electronic interface device receives data concerning the equipment and/or the environment within which the equipment is located as soon as the user is in the vicinity of the equipment/environment. The user can then be automatically apprised of characteristics of the equipment/environment and the user's subsequent actions can be performed readily responsive to such characteristics. This is particularly important in situations where the characteristics might relate to safe inspection of, or interaction with, the equipment.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1 is a schematic diagram of an embodiment of an equipment monitoring system comprising an embodiment of an electronic interface device located in an environment;

FIG. 2 is a schematic diagram of an embodiment of the electronic interface device in communication with a piece of equipment; and

FIG. 3 is a schematic diagram of the mobile electronic interface device of FIG. 2.

### DETAILED DESCRIPTION

The following description relates to various embodiments of an improved equipment monitoring system comprising an monitoring device or electronic interface device. It will be readily apparent that these embodiments are merely examples and that numerous variations and modifications are possible that embody the inventive aspects discussed herein. Several terms are used throughout this description to describe the salient features of the invention in conjunction with the accompanying figures. These terms, which may include “first”, “second”, “inner”, “outer”, and the like are not intended to overly limit the scope of the invention, unless so specifically indicated. The terms “about” or “approximately” as used herein may refer to a range of 80%-125% of the claimed or disclosed value. With regard to the drawings, their purpose is to depict salient features of the electronic interface device and are not specifically provided to scale.

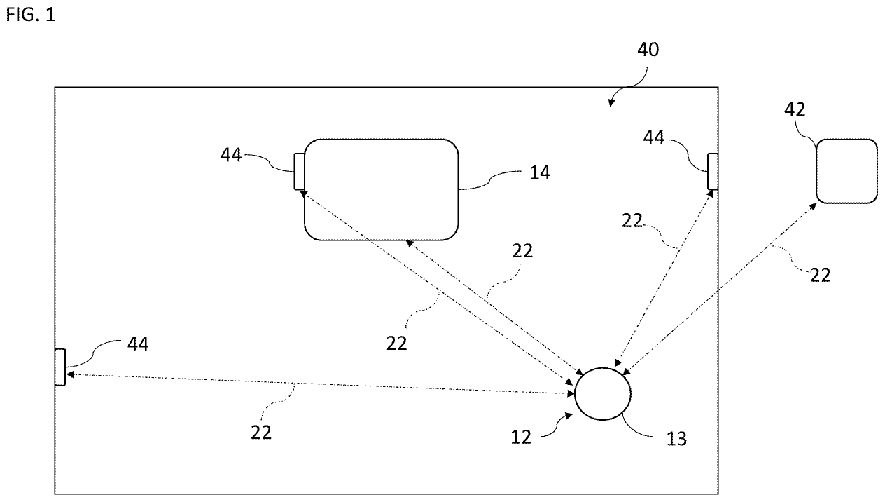

Referring to FIG. 1, an embodiment of an equipment monitoring system 10 generally comprises an electronic interface device in the form of a mobile electronic interface device, user wearable electronic interface device, or wearable device 12, and user-accessible processing equipment 14. The description and examples used herein my focus on the tasks of inspection and/or maintenance, however it should be appreciated that the equipment monitoring system may be used in any scenario in which user-access to equipment is required for any purpose including, but not limited to, power up/shut down, commissioning, decommissioning, maintenance and/or general inspection

One or more components of the equipment monitoring system 10 disclosed herein may be used with equipment located in hazardous and/or remote environments, and/or environments where time-efficient and safe user-interaction with the equipment is an important factor. However in other embodiments, one or more components of the equipment monitoring system 10 may be used with equipment that is not located in hazardous and/or remote environments, and/or environments.

Although the wearable electronic interface device 12 is represented in a schematic manner, it should be appreciated that the wearable device 12 may comprise any device that can be worn in any manner by a user including, but not limited to, formed as part of a user's (smart) clothing, a head-mounted device such as glasses, goggles and/or a visor or, an interactive head-mounted device. In an embodiment, the mobile device 12 may comprise a housing 13 or support that surrounds and/or supports one or more components of the mobile device 12.

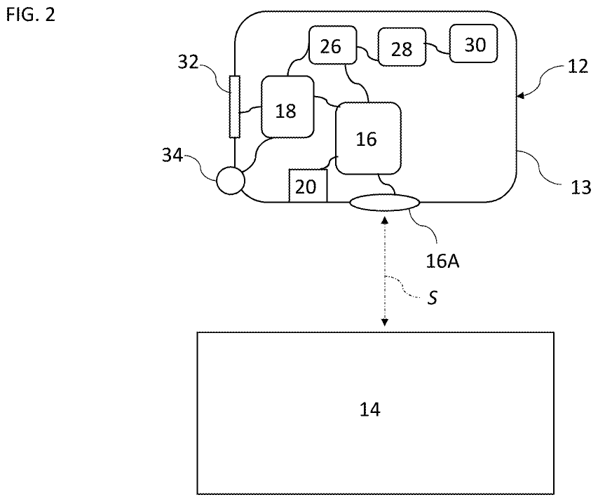

As illustrated in FIG. 1, the wearable device 12 is being worn by a user (not shown) in the vicinity of processing equipment 14 that requires some user-interaction or input. There will be a variety of expected and unanticipated reasons for user interaction with the equipment 14, however the following discussion and examples assume that a user is required to engage with the equipment 14 in a tactile physical manner including contact with at least part of the equipment 14 for maintenance or inspection purposes. It should be stated that since one of the operational characteristics of the equipment 14 is the temperature at which it operates, in some instances the operative must ensure that at least the section of the equipment 14 with which engagement is required is at a safe temperature for contact purposes prior to commencing the maintenance operation. Accordingly, the wearable device 12 comprises an input interface module 16 which may include an infrared radiation (IR) sensing capabilities. The input interface module 16 may further comprise an outwardly facing aperture 16A (FIG. 2) configured to sense and obtain IR data from the equipment 14 and/or environment 40 and analyze the data to determine the temperature of at least a part of the equipment 14, and more specifically the part(s) that require contact by the operative for maintenance purposes.

In an embodiment, the wearable device 12 also includes an output interface module 18. As shown, the output interface module 18 is configured to provide a visual display to the user. In the case of IR data received and analyzed by the input interface module 16 is then displayed by the output interface module 18 in a format that enables the user to easily identify whether the equipment/environment is at a safe temperature. Referring to FIGS. 1 and 2, the wearable device 12 may include communication functionality. The communication functionality may enable bidirectional communication with a remote processing device 42 such that the exchange of communication signals 22 with the remote processing device 42 can be performed at a location remote from the environment 40 within which the equipment 14 is located. The bidirectional communication may be achieved by any known such as Bluetooth or other computer readable instructions, data structures, program modules, or other data in a modulated data signal, such as a carrier wave or other transport mechanism, and including any information delivery media.

In an embodiment, the wearable device 12 is head-mounted or otherwise configured to be worn on the user's head. Since, as a matter of course, the user will tend to look directly at the equipment 14 or part of the equipment 14 they are about to touch, the outwardly facing aperture 16A or sensor of the input interface module 16 of the head-mounted wearable device 12 will naturally follow the user's line of sight S (FIG. 2). Accordingly, the temperature (or any other data/characteristic) of the part of the equipment 14 that the user is to engage with during the maintenance protocol will be automatically determined. According to this example, the output interface module 18 is configured to provide a visual temperature reading based on the IR data obtained from the input module 16. In other embodiments, the output interface module 18 may be configured to output or display an augmented reality so that, in addition to temperature information, a visual representation of the equipment 14 of interest to the user is also presented and overlayed on the temperature information. Such augmented reality functionality may then combine the temperature indication with the representation of equipment 14 so as to emphasize/clarify the temperature of the relevant part of the equipment 14, or at least whether a threshold temperature is exceeded.

The display function of the output interface module 18 may further comprise a visual display 32, audio output(s) 34, haptic output(s), or any combination thereof. The visual display may be customized using additional settings/options to enable the user to customize the display by changing color and/or brightness of the depicted relevant part of the equipment 14, or through the overlay of boundary markers for those portions of the equipment above the threshold temperature. Similarly, the audio and haptic outputs may be customized according to the user's preferences.

In the embodiment depicted in FIG. 1, the input interface module 16 is further configured to capture video images in addition to IR detection using the outwardly facing aperture or sensor 16A. Accordingly, the input interface module 16 is configured to capture an image of the equipment 14 as well as detect IR emissions from the equipment, which can be displayed by the output interface module 18 as an infrared image. It should also be appreciated that the input interface module 16 may be configured to detect any form of radiation and/or receive any type of data signals. In some embodiments, the input interface module 16 may comprise an active device or a passive device. In an embodiment, the input interface module 16 may be configured for bidirectional communication directly with one or more components of the equipment 14 to obtain data related to the status or the operating state of the equipment 14. The input interface module may further be configured to receive data from one or more sensors 44 positioned on the equipment 14 and/or in the environment 40 in which the equipment 14 is located.

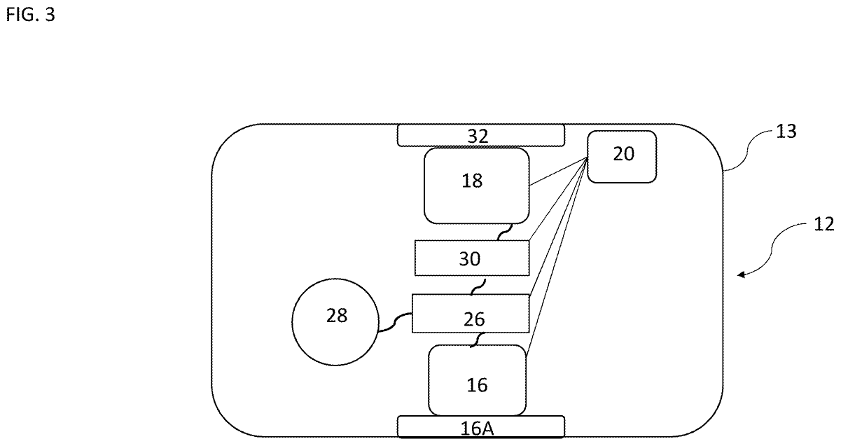

Turning now to FIG. 3, in addition to the input 16 and output 18 interface modules discussed above, the wearable device 12 further includes a processing module 26, storage module 28, and an augmented reality display module 30. Although illustrated separately in the schematic view, the processing, the storage, and augmented reality functionality may be provided in any appropriate configuration and combination of hardware, firmware and software by way of integrated processing and storage functionality.

As discussed above, the wearable device 12 may be configured to be worn on the user's head such that the outwardly facing aperture 16A of the input interface module 16 faces in the same direction as the general line of sight of the user in order to collect data from the equipment 14, or the part/section of the equipment 14 that is of interest by the user for inspection purposes. In this embodiment, the input interface module 16 is configured to capture an image of at least part of the equipment 14 and to sense the temperature thereof by way of IR detection. The part of the equipment 14 that will be imaged and detected for temperature will be that part of the equipment 14 that the user is looking at or that is in the user's line of sight, which is likely the part of the equipment 14 due to be accessed by the user. The temperature and image data captured by way of the input interface module 16 is then delivered to the processing module 26 which cooperates with the augmented reality display module 30 to create an augmented reality display of the part of the equipment 14 at the output interface module 18. In this example, the output interface module 18 includes a display screen or display image functionality configured to project an image into the line of sight S of a user comprising a representation of at least the part of the equipment 14. The projected image is readily apparent to the user without requiring any particular positional adaption or general change in the user's line of sight. The projected image is overlayed on additional information and readily presents the user with information corresponding to the displayed part of the equipment 14 they are intending to access. As a result, the user can easily determine whether the part of the equipment 14 is at a safe temperature to touch.

Of course, it should be appreciated that the above-mentioned discussion relates solely as an example to the potential characteristic of temperature of the equipment 14 and whether or not the equipment is safe for the user to engage with. As previously indicated, temperature is only one of many characteristics of the equipment 14 and the environment within which the equipment 14 is found that can be determined/monitored by way of the input interface module 16 of the wearable device 12. Through the use of appropriate detection functionality within the input interface module 16 and processing in the processing module 26, the detection/monitoring of a wide variety of characteristics of the equipment 14 and/or its environment can be performed. Accordingly, the output or presentation of the data pertaining to the characteristics of the equipment 14 or part of the equipment 14 to the user may vary and may be greatly simplified through the additional processing in cooperation with the augmented reality functionality of the augmented reality display module 30.

The disclosed equipment monitoring system 10 may comprise one or more wearable devices 12 that may be employed to improve user safety by automatically detecting an unsafe condition pertaining to the equipment 14 and/or the environment in which the equipment is located. In an embodiment, the unsafe condition may be detected through the use of video capture and/or IR detection and/or through data obtained by bidirectional communication between one or more components of the wearable device 12 and the equipment 14. The data/information obtained through the input interface module 16 may then be analyzed by the processing module 26 in conjunction with the storage module 28 and the analyzed data transmitted to the output interface module 18 of the wearable device 12 for display to the user. As illustrated in FIG. 3, the wearable device 12 includes a storage module 28 which may work in cooperation with the data processing module 26 and be configured to build a database/library of equipment/environments and related operational and/or unsafe operational characteristics. The storage module 28 may comprise, but is not limited to, volatile (e.g. random access memory (RAM)), non-volatile (e.g. read-only memory (ROM)), flash memory, or any combination or memory. The storage module 28 may include an operating system and one or more programming modules. The data processing module 26 may comprise an operating system that is suitable for controlling the data processing module functions. In an embodiment, control of the data processing module 26 may be done by an operating system that is located remote from the mobile electronic interface device 12.

As an example, an application comprising a set of data for each type of equipment that is scheduled for inspection may be loaded either directly or remotely into the storage module 28. The application may include safe and unsafe operational parameters pertaining to various aspects of the equipment 14. For example, the stored data may indicate how to de-energize or shut down the equipment 14 safely and, by way of the output interface module 18 may output information apprising the user as to which tools might be require and to the potential hazards that may result during the equipment shutdown. The stored application may further provide safety data for a particular piece of equipment 14 such that the mobile device 12 is configured to check equipment compliance as well as check local codes such as those relating to lockout/tag-out devices. In addition, the mobile device 12 may be configured to verify other performance and/or safety requirements, such as determining whether Ingress Protection was correctly installed and is functioning. At a more basic level, stored processing steps in an application could orchestrate checks that the power supply of a piece of equipment 14 has been deactivated or disabled as required prior to inspection. In an embodiment, the mobile device 12 is configured to record the inspection/maintenance that is performed and use this as a record that the relevant standards of workmanship have been achieved. For Hazardous areas this could be used as part of the traceability.

The functionality of any such application may also employ communications functionality 20 of the mobile device 12 so as to provide any required smart link for ensuring safe operating conditions for the equipment 14. In an embodiment, inbuilt data recording functionality may be provided in the mobile device 12, or indeed at a remote processor 42 to record the steps or actions taken during the user's interaction with equipment 14 and which can be stored and used in the future to verify the appropriate steps to be taken for similar or repeated activities.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure.

What is claimed is:

1. A equipment monitoring device configured to be worn by a user and comprising:
an input interface module comprising an input sensor, the input interface module configured to,
receive operational data from at least one of a piece of equipment and a sensor, the sensor is configured to sense and transmit data to the input interface module pertaining to an environmental parameter proximate a piece of equipment,
analyze the received data, and
transmit analyzed data information; and
an output interface module comprising a display, the output interface module being in communication with the input interface module and configured to,
receive the transmitted analyzed data information from the input interface module, and
output the analyzed data information to the display, wherein the analyzed data information is responsive to the received data,
wherein the input interface sensor is configured to automatically capture visual images of the piece of equipment in a line of sight of the user.

2. The mobile equipment monitoring device of claim 1, wherein the input interface module comprises a processor and a storage component.

3. The mobile equipment monitoring device of claim 2, further comprising an eyewear device configured to communicate with the output interface module.

4. The mobile equipment monitoring device of claim 3, wherein analyzed data is configured to be displayed using the eyewear device.

5. The mobile equipment monitoring device of claim 4, wherein the output interface module is configured to overlay the analyzed data on the visual images captured by the input interface module.

6. The mobile equipment monitoring device of claim 2, wherein at least one of the input interface module and the output interface module is configured for bidirectional wireless communication with a remote processing module.

7. The mobile equipment monitoring device of claim 2, further comprising a GPS receiver, wherein receipt and output of data is controlled according to a GPS position of the mobile equipment monitoring device.

8. The mobile equipment monitoring device of claim 2, wherein the input interface module is configured to output analyzed data information based on the line of sight of the user.

9. The mobile equipment monitoring device of claim 2, wherein the output interface module is configured to output analyzed data information to the user by one or more of a visual display, audio signals, and haptic signal.

10. A method of equipment monitoring comprising:
receiving operational data pertaining to a piece of equipment being engaged by user;
receiving environmental data regarding one or more environmental parameters proximate the equipment;
analyzing the operational and environmental data using one or more processors to,
determine operating status information of the equipment based on the operating data, and
determine safety information based on the operating status information and the environmental data; and
outputting the operating status and safety information to the user.

11. The method of claim 10, further comprising receiving location data for the user and the outputting of the operation status and the safety information in response to the location data.

12. The method of claim 10, wherein the outputting comprises at least one of a visual display, audio signals, and haptic signals.

13. The method of claim 10, further comprising capturing an image of the equipment in a user's line of sight and outputting the operation status and the safety information based on the captured image.

14. The method of claim 10, wherein the analyzing is performed at a location that is remote from the user.

15. The method of claim 10, wherein the outputting comprises an augmented reality display.

16. A device as claimed in claim 12, and arranged such that the visual display is configured to display an image of at least part of the equipment.
